(19) United States
(12) Patent Application Publication
(10) Pub. No.: US 2008/0225088 A1
(43) Pub. Date: Sep. 18, 2008

(54) Fluid jet device and method for manufacturing the same

(75) Inventors: Chen-Kuei Chung, Tainan (TW); Yi-Zhi Hong, Taipei (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/076,146

(22) Filed: Mar. 14, 2008

(30) Foreign Application Priority Data
Mar. 16, 2007 (TW) 96109201

(51) Int. Cl. B41J 2/05; G11B 5/127

(52) U.S. Cl. 347/62; 347/64; 216/16; 216/27

(57) ABSTRACT

A fluid jet device and a method for manufacturing the same are provided. The fluid jet device includes a substrate, a resistor layer and an orifice layer. The resistor layer is formed on the substrate. The resistor layer includes tantalum, silicon and nitrogen. The orifice layer is disposed on over the substrate to form a manifold between the orifice layer and the substrate. The manifold is used for containing a fluid. The orifice layer has a nozzle communicated with to the manifold. When the resistor layer is charged, the resistor layer heats the adjacent fluid to generate a bubble therein so as to allow the fluid to be pushed out of the nozzle.

This application claims the benefit of Taiwan application Serial No. 96109201, filed Mar. 16, 2007, the subject matter of which is incorporated herein by reference.

### BACKGROUND OF THE INVENTION

1. Field of the Invention

The invention relates in general to a fluid jet device and a method for manufacturing the same, and more particularly to a resistor layer of a fluid jet device and a method for manufacturing the same.

2. Description of the Related Art

Nowadays, the printhead of the inkjet printer in the commercial application may be mainly divided into two types, a piezoelectric inkjet type and a thermal inkjet type. As regards the piezoelectric inkjet type, i.e. EPSON printhead, the ink is pushed out of a nozzle by a piezoelectric actuator to form a droplet of ink. As regards the thermal inkjet type, i.e. HP and Canon printhead, the ink is heated by the resistor in the printhead to generate bubbles, which push a droplet of ink from an ink-supply room out of a nozzle.

Referring to FIG. 1, a cross-sectional view of a conventional thermal inkjet printhead is shown. As shown in FIG. 1, the thermal inkjet printhead 10 includes a resistor layer 12, a protection layer 14, an ink-supply room 16 and a nozzle 18. The resistor layer 12 can be made of tantalum-aluminum (TaAl). Other exemplary resistors also can be made of HfB₂, ZrB₂ or polysilicon etc. The protection layer 14 is disposed on the resistor layer 12, and the protection layer 14 could be a dual-layer structure which comprising a silicon nitride (Si₃N₄) layer and a silicon carbide (SiC) layer. The silicon nitride layer directly covers the resistor layer 12, as so to assist a following layer (i.e. the silicon carbide layer) in adhesion. The silicon carbide layer is formed on the silicon nitride layer, and the silicon carbide layer is used for protecting the resistor layer 12. In general, the printhead 10 may further include a passivation layer, which is formed on the protection layer 14, to prevent the resistor layer 12 from erosion caused by the ink. During printing, as the ink-supply room 16 is filled with ink and the resistor layer 12 is charged to generate heat, the resultant heat of the resistor layer 12 will be transmitted through the protection layer 14 and the passivation layer to heat and vaporize the ink. The ink bubbles, and then a droplet of the ink is pushed out of the nozzle 18 from the ink-supply room 16.

A desirable resistor layer should exhibit high strength, high stress-variation resistance, high oxidation resistance and high heat resistance etc. The resistor layer of the printhead on the market is mainly made of tantalum-aluminum (TaAl). Although the maximum resistance coefficient of tantalum-aluminum is below 250 μΩ-cm, it is an attempt therefore to develop a material that can act as the resistor layer to exhibit higher resistance coefficient, higher strength, higher heat-resistance and higher life-time.

### SUMMARY OF THE INVENTION

The invention is directed to a fluid jet device. A new material as the resistor layer replaces the conventional materials, so that the fluid jet device of the present invention could exhibit high strength, high resistance coefficient and high heat resistance.

According to a first aspect of the present invention, a fluid jet device is provided. The fluid jet device includes a substrate, a resistor layer and an orifice layer. The resistor layer is formed on the substrate. The resistor layer includes tantalum, silicon and nitrogen. The orifice layer is disposed on over the substrate to form a manifold between the orifice layer and the substrate. The manifold is used for containing a fluid. The orifice layer has a nozzle communicated with to the manifold. When the resistor layer is charged, the resistor layer heats the adjacent fluid to generate a bubble therein so as to allow the fluid to be pushed out of the nozzle.

According to a second aspect of the present invention, a method for manufacturing a fluid jet device is provided. The method comprises the following steps. First, a substrate is provided. Next, a resistor layer is sputtered on the substrate. The resistor layer includes tantalum, silicon and nitrogen. Then, the resistor layer is patterned. Afterwards, an orifice layer is disposed on the substrate to form a manifold between the orifice layer and the substrate. The manifold is used for containing a fluid. The orifice layer has a nozzle communicated with the manifold.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a cross-sectional view of a conventional thermal inkjet printhead.

FIGS. 2A-2K are cross-sectional views showing a method for manufacturing a fluid jet device according to the preferred embodiment of the present invention.

FIG. 3 shows a diagram illustrating an analysis of X-ray diffraction analysis.

FIG. 4 shows a diagram illustrating an analysis of X-ray diffraction analysis after a heating process.

FIG. 5 shows a diagram illustrating a resistance variation of the resistor layer with twice heating-cooling process.

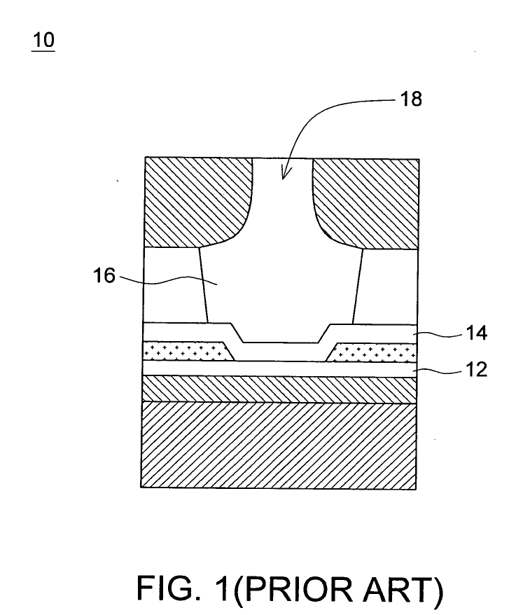

### DETAILED DESCRIPTION OF THE INVENTION

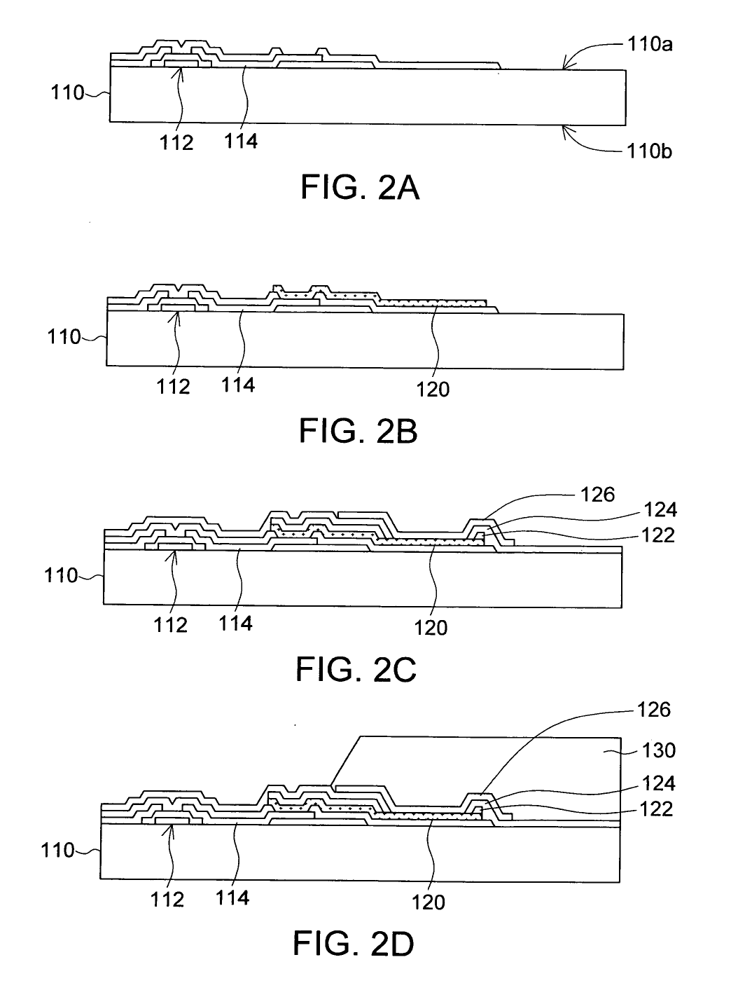

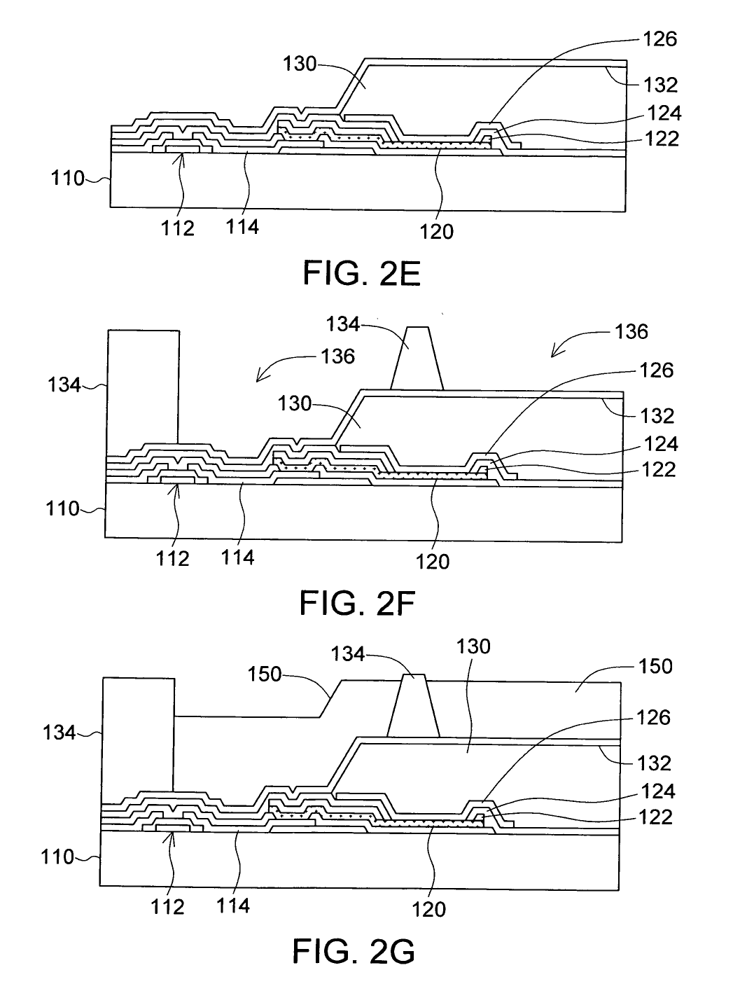

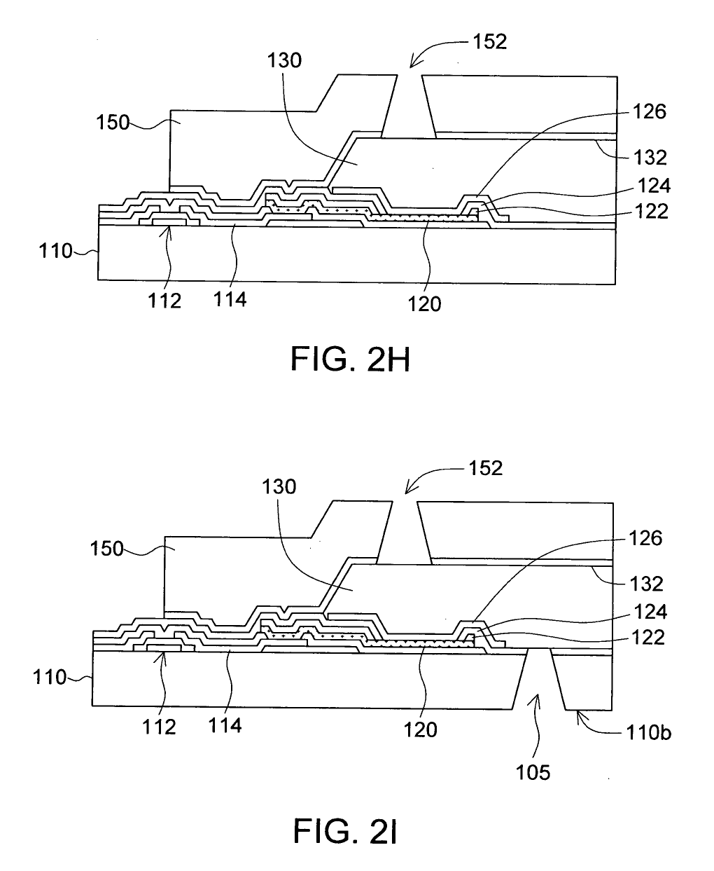

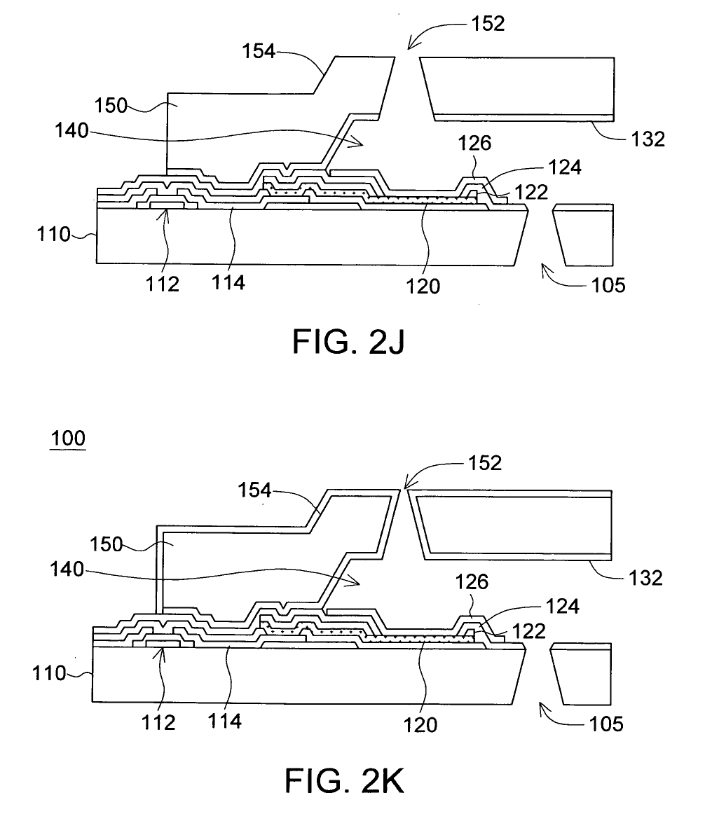

Referring to FIGS. 2A-2K, cross-sectional views showing a method for manufacturing a fluid jet device according to the preferred embodiment of the present invention are shown. The method for manufacturing a fluid jet device according to the present embodiment includes following steps. First, as shown in FIG. 2A, a substrate 110, e.g. a silicon wafer, is provided. The substrate 110 has a first surface 110a and a second surface 110b. Furthermore, a drive circuit 112 is formed on the first surface 110a of the substrate 110.

Next, as shown in FIG. 2B, a resistor layer is sputtered on the substrate 110, and the resistor layer is patterned to form a resistor layer 120. The resistor layer 120 includes tantalum (Ta), silicon (Si) and nitrogen (N), but there is too numerous to enumerate all of the methods for sputtering the resistor layer on the substrate. For more particularly, one example described in detail below is provided. A sputter is provided, and the parameters of the sputter are set as that a power of a DC power supply and a RF AC power supply is set in a range of 10-3000 W, a gas flow ratio of (N₂/(Ar+N₂)) is set in a range of 1-15% and a bias voltage is set in a range of 20-200V. A silicon target and a tantalum target are provided at a cathode of the sputter, and the substrate is posited at an anode of the sputter. Under this circumstance, the resistor layer including tantalum, silicon and nitrogen is deposited on the substrate. However, this example is not to be construed as limiting the scope of the invention. Any one who is skilled in the technology of the art can understand that the resistor layer of the present embodiment can also be produced by either using an alloy target made of silicon-tantalum as the target with the same parameters or using an alloy target made of silicon-tantalum-nitrogen as the target without nitrogen gas. Besides, the patterned resistor layer 120 could be etched with a fluoride-containing gas by a dry etching technology. For example, the fluoride-containing gas could either include C₂CIF₅ and SF₆ or include SF₆ and O₂.

Afterwards, as shown in FIG. 2C, a conduction wire 122 is formed on the resistor layer 120, a protection layer 124 covers the resistor layer 120 and the conduction wire 122, and a passivation layer 126 is formed on the protection layer 124 and drive circuit 112. The protection layer 124 is made of silicon carbide (SiC), and the passivation layer 126 includes tantalum (Ta). In this respect, it should be recognized that the resistor layer of the present embodiment exhibits good adhesion to silicon carbide. Therefore, a silicon nitride layer could be omitted by using a single-layer structure made of silicon carbide as the protection layer 124. Accordingly, a procedure and a material could be economized in the manufacturing method and the resistor layer 120 could be more effective in heating the ink through the protection layer 124 having the single-layer structure.

Then, an orifice layer (as 150 shown in FIG. 2K) is formed on the substrate 110, and then a manifold 140 is formed between the orifice layer 150 and the substrate 110. The manifold 140 is used for containing a fluid. Besides, the orifice layer 150 could be a conduction material or a non-conduction material. In the manufacturing method of the orifice layer 150, it is different in employing the conduction material or the non-conduction material. More details of the differences are discussed below.

While the orifice layer 150 is a conduction material, the manufacturing method of the orifice layer 150 includes following steps. First, as shown in FIG. 2D, a sacrifice layer 130 is formed over the substrate 110. The sacrifice layer 130 could be poly-silicon, phosphosilicate glass (PSG) or photoresist, and the sacrifice layer 130 is used for reserving a region to form the manifold (as 140 shown in FIG. 2K). Then, as shown in FIG. 2E, a conduction layer 132 covers the sacrifice layer 130 and the substrate 110. For example, the conduction layer 132 could include Au/Ti, Ag/Ti or Au/TiW. Next, as shown in FIG. 2F, a patterned photoresist 134 is formed on the conduction layer 132. The patterned photoresist 134 has a plurality of openings 136 exposing the conduction layer 132. Afterwards, as shown in FIG. 2G, a conduction material is electroplated on the openings 136, and the patterned photoresist 134 and a part of the conduction layer 132 are removed so as to form the orifice layer 150 having a nozzle 152 (as shown in FIG. 2H). Preferably, the orifice layer could include aurum (Au), nickel (Ni) or nickel-cobalt (NiCo).

While the orifice layer 150 is a non-conduction material such as a polymer (e.g. a SU-8 photoresist manufactured and sold by Micro-Chemical, a PI photoresist manufactured and sold by Dupont, or a WPR photoresist manufactured and sold by JSR), the manufacturing method thereof would be partially different from that of the orifice layer 150 which is made of a conduction material. The different parts of the method for manufacturing the orifice layer made of a non-conduction material will be described below. As result of the non-conduction material being ineffective in electroplating procedures, the conduction layer will be omitted in this situation. Therefore, a patterned photoresist is directly formed on the sacrifice layer, and then the openings are filled with a non-conduction material by a spin coating technology.

Next, as shown in FIG. 2I, the substrate 110 is etched from a second surface 110b of the substrate 110 to form a through hole 105 (two openings at two ends of the through hole appear on the first surface 110a and the second surface 110b respectively). The sacrifice layer 130 is exposed to the outside form the through hole 105.

Afterwards, as shown in FIG. 2J, the sacrifice layer 130 is removed, so as to form the manifold 140 between the orifice layer 150 and the substrate 110. The manifold 140 is used for containing a fluid, and the nozzle 152 is communicated with the manifold 140.

Finally, as shown in FIG. 2K, a metallic chemicals-resistance layer 154 is deposited on the orifice layer 150 by an oxidation-reduction reaction. Preferably, the oxidation-reduction reaction could be an electroless plating reaction, and the metallic chemicals-resistance layer 154 could include aurum (Au) for increasing the strength of the orifice layer 150. Because all structures are directly formed on a silicon wafer or a substrate in the manufacturing method of the present embodiment, the fluid jet device of the present embodiment would be a monolithic fluid jet device. Therefore, it could reduce the production costs on a mass production.

Referring to FIG. 2K, a structure diagram illustrating a fluid jet device according to the preferred embodiment of the present invention is shown. According to the manufacturing method above, the fluid jet device 100 includes a substrate 110, a resistor layer 120 and an orifice layer 150. The resistor layer 120 is formed on the substrate 110. The resistor layer 120 includes tantalum (Ta), silicon (Si) and nitrogen (N). The orifice layer 150 is disposed on over the substrate 110 to form a manifold 140 between the orifice layer 150 and the substrate 110. The manifold 140 is used for containing a fluid. The orifice layer 150 has a nozzle 152 communicated with to the manifold 140. When the resistor layer 120 is charged, the resistor layer 120 heats the adjacent fluid to generate a bubble therein so as to allow the fluid to be pushed out of the nozzle 152.

In this respect, it could be note that the resistor layer 120, manufactured by the method described above in this embodiment, has several properties outlined below.
(1) The resistor layer 120 has a resistance coefficient of 150-1500 μΩ-cm. As regards the resistance coefficient, it is much higher than a conventional resistor made of tantalum-aluminum (TaAl), whose the maximum resistance coefficient is 250 μΩ-cm.
(2) The resistor layer 120 has a peak at 2θ of 35˜45 degree with X-ray diffraction analysis. The resistor layer 120 is amorphous or amorphous-like.
(3) The resistor layer 120 is stabilized within a temperature of 500° C.
(4) The resistor layer 120 has a temperature coefficient of resistance (TCR) in a range of ±500 ppm/° C.

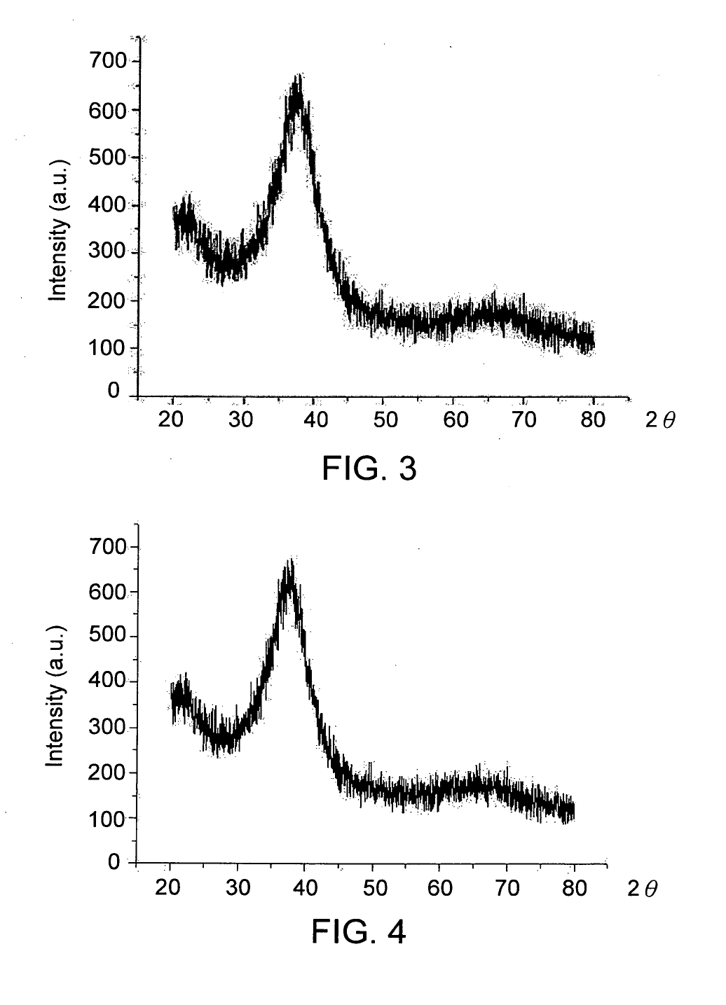

Experiments are provided and described in detail below. In these experiments, a to-be-measured resistor layer is manufactured by a reactive magnetron sputtering technology, that using a silicon target and a tantalum target, and parameters in manufacturing are set as that a power of a DC power supply is set 100 W, a RF AC power supply is set 225 W, a gas flow ratio of (N₂/(Ar+N₂)) is set 5%, a bias voltage is set 100V and a pressure is set 1.5×10⁻³ torr. Afterwards, the to-be-measured resistor layer is analyzed by a four-point probe analysis, a XRD analysis, a SEM/EDX analysis and a thermo-stability analysis. The resistor layer 120 has a resistance coefficient of 327.17 μΩ-cm. FIG. 3 shows a diagram illustrating an analysis of X-ray diffraction analysis The resistor layer 120 has a peak at 2θ of 37.01 degree with X-ray diffraction analysis. The resistor layer 120 is amorphous or amorphous-like.

Thermo-Stability Analysis:

After heating the to-be-measured resistor layer to a temperature of 500° C. and quenching, the to-be-measured resistor layer is analyzed again by X-ray diffraction analysis. The X-ray diffraction analysis result is shown in FIG. 4. As shown in FIG. 4, a diagram illustrating an analysis of X-ray diffraction analysis after a heating process is shown. Referring to FIG. 3 and FIG. 4, it shows that the lattice structure of the specimen is not transformed after heating and quenching. Therefore, it should be indicated that the resistor layer 120 is stabilized within a temperature at 500° C. or more.

Temperature Coefficient of Resistance (TCR):

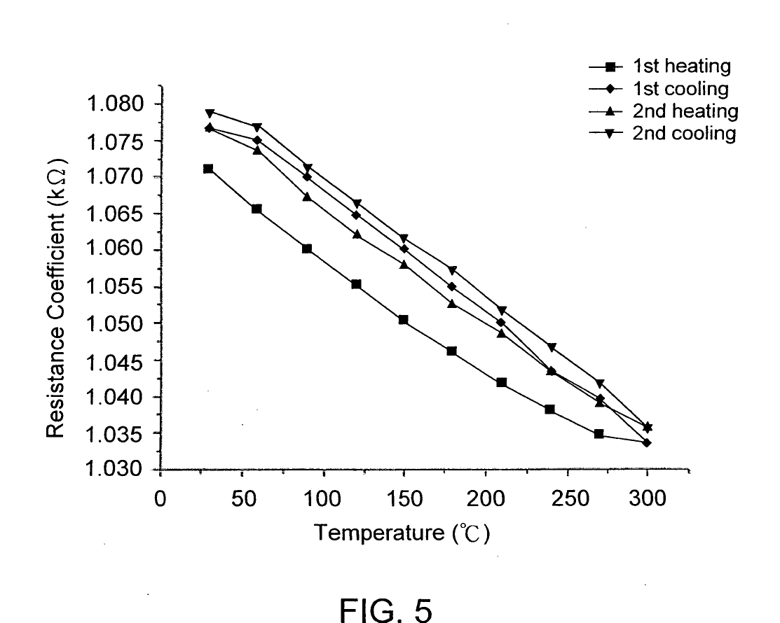

Referring to FIG. 5, a diagram illustrating a resistance variation of the resistor layer with twice heating-cooling process is shown. In the first heating-cooling process (the temperature varying in a range within 25-300° C.), it exhibits a larger variation of the resistance value. In the second heating-cooling process, it exhibits a smaller variation of the resistance value. According to TCR formula, TCR=(R2−R1)/(R1*(T2−T1)), the TCR of the resistor layer 120 is calculates as −139 ppm/° C.

The fluid jet device and the manufacturing method thereof disclosed above, whose advantages of the resistor layer including tantalum, silicon, nitrogen could be indicated below. The resistor layer of the present embodiment exhibits high strength and excellent wear-resistance. Moreover, the resistor layer has a low temperature coefficient of resistance (TCR) and a superior thermo-stability. Furthermore, the resistance coefficient of the resistor layer is relatively high, so as to generate more heat while the same current is applied and exhibit a high heating efficiency. Besides, the resistor layer of the present embodiment is cohered well to the protection layer, therefore a silicon nitride layer could be omitted, and using a single-layer structure as the protection layer is effective in increasing the heat efficiency while the heat is transmitted to the manifold from the resistor layer.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fluid jet device comprising:
a substrate;
a resistor layer, formed on the substrate, wherein the resistor layer comprises tantalum (Ta), silicon (Si), and nitrogen (N); and
an orifice layer, disposed on over the substrate to form a manifold between the orifice layer and the substrate, the manifold being used for containing a fluid, the orifice layer having a nozzle communicated with the manifold;
wherein when the resistor layer is charged, the resistor layer heats the fluid to generate a bubble therein so as to allow the fluid to be pushed out of the nozzle.

2. The fluid jet device according to claim 1, wherein the resistor layer has a resistance coefficient of 150-1500 μΩ-cm.

3. The fluid jet device according to claim 1, wherein the resistor layer has a peak at 2θ of 35˜45 degree with X-ray diffraction analysis.

4. The fluid jet device according to claim 1, wherein the resistor layer is amorphous or amorphous-like.

5. The fluid jet device according to claim 1, wherein the resistor layer is stabilized within a temperature of 500° C.

6. The fluid jet device according to claim 1, wherein the resistor layer has a temperature coefficient of resistance (TCR) in a range of ±500 ppm/° C.

7. The fluid jet device according to claim 1 further comprising:
a drive circuit, formed on the substrate and electrically connected to the resistor layer; and
a conduction wire, formed on the resistor layer.

8. The fluid jet device according to claim 1, wherein the substrate has a first surface, a second surface and a through hole therebetween, the resistor layer formed on the first surface.

9. The fluid jet device according to claim 1 further comprising:
a protection layer, covering the resistor layer.

10. The fluid jet device according to claim 9, wherein the protection layer is made of silicon carbide (SiC).

11. The fluid jet device according to claim 9 further comprising:
a passivation layer, formed on the protection layer.

12. The fluid jet device according to claim 11, wherein the passivation layer comprises tantalum (Ta).

13. The fluid jet device according to claim 1 further comprising:
a metallic chemicals-resistance layer, formed on the orifice layer.

14. The fluid jet device according to claim 13, wherein the metallic chemicals-resistance layer comprises aurum (Au).

15. The fluid jet device according to claim 1, wherein the orifice layer comprises aurum (Au), nickel (Ni) or nickel cobalt (NiCo).

16. The fluid jet device according to claim 1, wherein the orifice layer is a polymer.

17. The fluid jet device according to claim 1, wherein the resistor layer is manufactured by a reactive magnetron sputtering technology, a power of a DC power supply and a RF AC power supply in a range of 10-3000 W, a gas flow ratio of (N₂/(Ar+N₂)) in a range of 1-15% and a bias voltage in a range of 20-200V applied to produce a plasma impacting a silicon target and a tantalum target so as to deposit the resistor layer on the substrate.

18. The fluid jet device according to claim 1, wherein the resistor layer is manufactured by a reactive magnetron sputtering technology, an alloy target made of silicon-tantalum impacted by a plasma comprising nitrogen to deposit the resistor layer on the substrate.

19. The fluid jet device according to claim 1, wherein the resistor layer is manufactured by a reactive magnetron sputtering technology, and an alloy target made of tantalum-silicon-nitride is for manufacturing the resistor layer.

20. A method for manufacturing a fluid jet device, comprising:
providing a substrate;
sputtering a resistor layer on the substrate, wherein the resistor layer comprises tantalum (Ta), silicon (Si) and nitrogen (N);
patterning the resistor layer; and
disposing a orifice layer on the substrate to form a manifold between the orifice layer and the substrate, the manifold being used for containing a fluid, the orifice layer having a nozzle communicated with the manifold.

21. The method according to claim 20, wherein the step of sputtering the resistor layer comprises:
providing a sputter and setting parameters of the sputter, comprising:
setting a power of a DC power supply and a RF AC power supply in a range of 10-3000 W;
setting a gas flow ratio of (N₂/(Ar+N₂)) in a range of 1-15%; and
setting a bias voltage in a range of 20-200V; and
providing a silicon target and a tantalum target at a cathode of the sputter and positing the substrate at a anode of the sputter to deposit the resistor layer comprising tantalum, silicon and nitrogen on the substrate.

22. The method according to claim 20, wherein the step of sputtering the resistor layer comprises:
providing a sputter and setting parameters of the sputter, comprising:
setting a power of a DC power supply and a RF AC power supply in a range of 10-3000 W;
setting a gas flow ratio of (N₂/(Ar+N₂)) in a range of 1-15%; and
setting a bias voltage in a range of 20-200V; and
providing an alloy target made of silicon-tantalum at a cathode of the sputter and positing the substrate at a anode of the sputter to deposit the resistor layer comprising tantalum, silicon and nitrogen on the substrate.

23. The method according to claim 20, wherein the step of sputtering the resistor layer comprises:
providing a sputter and setting parameters of the sputter, comprising:
setting a power of a DC power supply and a RF AC power supply in a range of 10-3000 W; and
setting a bias voltage in a range of 20-200V; and
providing an alloy target made of silicon-tantalum-nitrogen at a cathode of the sputter and positing the substrate at a anode of the sputter to deposit the resistor layer comprising tantalum, silicon and nitrogen on the substrate.

24. The method according to claim 20 further comprising:
forming a drive circuit, the drive circuit being electrically connected to the resistor layer.

25. The method according to claim 20 further comprising:
forming a conduction wire on the resistor layer;
forming a protection layer on the resistor layer and on the conduction wire; and
forming a passivation layer on the protection layer.

26. The method according to claim 25, wherein the protection layer is made of silicon carbide (SiC).

27. The method according to claim 25, wherein the passivation layer comprises tantalum (Ta).

28. The method according to claim 20, wherein the step of patterning the resistor layer comprises:
etching the resistor layer with a fluoride-containing gas by a dry etching technology.

29. The method according to claim 28, wherein the fluoride-containing gas comprises C₂CIF₅ and SF₆.

30. The method according to claim 28, wherein the fluoride-containing gas comprises SF₆ and O₂.

31. The method according to claim 20, wherein the step of disposing the orifice layer comprises:
forming a sacrifice layer over the substrate;
forming a conduction layer on the sacrifice layer and the substrate;
forming a patterned photoresist layer on the conduction layer, the patterned photoresist layer having a plurality of openings exposing the conduction layer;
electroplating a conduction material in the openings and removing the patterned photoresist layer and part of the conduction layer to form the orifice layer having a plurality of nozzles; and
removing the sacrifice layer to form a manifold between the orifice layer and the substrate, wherein the nozzles are communicated with the manifold.

32. The method according to claim 31, wherein the sacrifice layer comprises a poly-silicon, phosphosilicate glass (PSG) or photoresist.

33. The method according to claim 31, wherein the conduction layer comprises Au/Ti, Ag/Ti or Au/TiW.

34. The method according to claim 31, wherein the orifice layer comprises aurum (Au), nickel (Ni) or nickel-cobalt (NiCo).

35. The method according to claim 31, wherein the substrate has a first surface and a second surface, the resistor layer is formed on the first surface, before the step of removing the sacrifice layer, the method for manufacturing a fluid jet device further comprising:
etching the substrate from the second surface to form a through hole, the sacrifice layer being exposed from the through hole.

36. The method according to claim 20, wherein the step of disposing the orifice layer comprises:
forming a sacrifice layer over the substrate;
forming a patterned photoresist layer on the sacrifice layer, the patterned photoresist having a plurality of openings exposing the sacrifice layer;
filling the openings with a non-conduction material and removing the patterned photoresist layer to form the orifice layer having at least a nozzle; and
removing the sacrifice layer to form a manifold between the orifice layer and the substrate, wherein the nozzle is communicated with the manifold.

37. The method according to claim 20 further comprising:
depositing a metallic chemicals-resistance layer on the orifice layer by an oxidation-reduction reaction.

38. The method according to claim 37, wherein the oxidation-reduction reaction is an electroless plating reaction, and the metallic chemicals-resistance layer comprises aurum (Au).
